(19) United States
(12) Patent Application Publication
(10) Pub. No.: US 2003/0046330 A1
(43) Pub. Date: Mar. 6, 2003

(54) Selective offloading of protocol processing

(76) Inventor: John W. Hayes, Los Gatos, CA (US)

Correspondence Address: Anglin & Giaccherini, P.O. Box 1146, Carmel Valley, CA, 93924, US

(21) Appl. No.: 09/946,144

(22) Filed: Sep. 4, 2001

(51) Int. Cl. G06F 15/16

(52) U.S. Cl. 709/201

(57) ABSTRACT

Methods and apparatus for the selective offloading of protocol processing are disclosed. In a preferred embodiment of the invention, computationally intensive and memory bandwidth intensive protocol processing tasks are offloaded from the host processor of a computer to an auxiliary processor. In a preferred embodiment, the auxiliary processor has the ability to return the requested task, thereby allowing complex, non-performance oriented tasks to be performed by the host processor. This enables the auxiliary processor to have necessary resources for the specific tasks for which it has been designed, and does not require that the auxiliary processor has enough resources to accomplish the task of offloading the entire network protocol processing task. In one embodiment, the auxiliary processor may refuse requests to offload additional tasks from the host processor when resources are low. In a preferred embodiment, the auxiliary processor is able to discern between various network applications running over the same network protocol and treat them differently, even though both applications are utilizing the same network and transport protocols. This capability allows the optimization of the protocol processing for each network application.

### INTRODUCTION

The title of this Patent Application is Selective Offloading of Protocol Processing. The Applicant, John William Hayes, of 24700 Skyland Road, Los Gatos, Calif. 95033, is a citizen of the United States of America.

### FEDERALLY SPONSORED RESEARCH OR DEVELOPMENT

None.

### FIELD OF THE INVENTION

The present invention pertains to methods and apparatus for dynamically offloading selected portions of a protocol processing task to a auxiliary processor, causing memory bandwidth or CPU processing intensive tasks to be performed by the auxiliary processor or otherwise in a manner that reduces the memory bandwidth or host CPU processing cycles consumed by the performing the protocol processing task. More particularly, one preferred embodiment of the invention enables the offloading auxiliary processor to deposit incoming user data directly into the user's memory space, bypassing the placing of a copy of the data into the operating system's memory and thereby reducing the number of times the received data is copied, enabling a zero-copy architecture. In another preferred embodiment, the invention enables the offloading auxiliary processor to transfer protocol processing back to the host CPU in the event of errors, low resources or other events that are not considered routine for the auxiliary processor to perform. This capability allows one preferred embodiment to have less processing power or memory resources in the auxiliary processor and still perform the mainline or “fastpath” code efficiently without being burdened by having to maintain the slower and much more complex error handling and recovery routines which are them implemented back on the host CPU. The present invention also includes a filtering function which enables the network interface to select between a plurality of protocol processing functions, which although they may perform the same protocol processing tasks, differ in how the tasks are distributed between the host CPU and an offloading auxiliary processor.

### BACKGROUND OF THE INVENTION

Over the past several years, since wide adoption of 100 megabit (Mb) and gigabit (Gb) Ethernet systems, the portion of the host CPU cycles that are spent communicating via a computer network has been forced to increase to handle the greater amount protocol processing that is required. The most common protocol used for computer networking is the TCP/IP protocol. As the demands for more CPU cycles to process the networking protocol traffic has increased, several strategies have emerged to mitigate this increase. The standard accepted strategies all offload specific, fixed functions of the protocol, specifically the calculations of the TCP and IP checksums, or have focused on reducing the number of times the network interface card (NIC) interrupts the host CPU. Both of these strategies have been used successfully together to reduce the overall protocol processing load on the host CPU, but neither offloads the data movement and reassembly functions of the protocol. Other strategies have focused on putting the entire networking protocol stack implementation on an offloading auxiliary processor to completely offload the host operating system of the protocol processing task. While this may work for a limited set of applications, it requires a costly auxiliary processor with a large memory capacity and complicated interactions with the host CPU.

None of the above solutions provides a dynamic mechanism to offload portions of a data stream's network protocol processing on a transactional or on a single event basis. The development of such a system would constitute a major technological advance, and would satisfy long felt needs and aspirations in both the computer networking and computer server industries.

### SUMMARY OF THE INVENTION

The present invention provides methods and apparatus for delivering selective offloading of protocol processing from a host CPU to an offloading auxiliary processor. Selective offloading of protocol processing enables a host to offload the most computationally intensive, memory bandwidth intensive and performance critical portions of the protocol processing task to an auxiliary processor without requiring the auxiliary processor to perform the full suite of functions necessary to perform a complete protocol processing offload. This capability enables the offloading auxiliary processor to be built with fewer resources, and thus more inexpensively. The offloading host will only offload the portions of the protocol processing task that the auxiliary processor can process. If the auxiliary processor is requested to perform an action that it is unable to perform, for any reason, is simply returns the request back to the host CPU. The request may be partially completed or not completed at all. This allows “fastpath” functions to be offloaded while more complex, but slower functions such as error handling, resequencing and lost packet recovery and retransmission to be handled by the host CPU.

Each protocol processing task is offloaded individually, with the host CPU regaining control at the end of each protocol processing task or sequence of tasks. This allows the auxiliary processor to maintain only the state information pertinent to the tasks that the auxiliary processor is currently performing. While the host regains control at the end of each task, multiple tasks and sequences of tasks may be chained together to minimize the need to resynchronize state information with the host CPU.

When making an offload request, the host CPU includes information regarding the protocol to be offloaded. It is expected that the protocol will be a combination of protocols including the network protocol, the transport protocol and the application protocol. It can be any protocol or set of protocols in the seven layer ISO protocol reference model. When multiple protocols of different layers are taken together, each unique combination of protocols is treated as a separate protocol. This allows the underlying protocols to be tailored to the requirements of the application and the application protocol. One preferred embodiment of this is iSCSI over TCP/IP. Another preferred embodiment is VIA over TCP/IP.

Methods of constructing the auxiliary processor include adding network processors and memory to a NIC, adding network processors, memory and hardware state machines to a NIC or by adding hardware state machines and memory to a NIC. Additionally, in place of a NIC, this functionality can be placed on the main processor board or “motherboard” of the CPU processor, or embedded within the I/O bridge.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 is an illustration which shows the relationship between computers C, a computer network E, a network router R, a network switch S and a network attached storage system D.

FIG. 2 is an illustration which shows the relationship between the network interface NIC, the computer network E and other primary components of a computer C including the central processor CPU, the memory controller MC and the memory M.

FIG. 3 is an illustration of the classical architectural model of host based protocol processing function.

FIG. 4 is an illustration of the full protocol processing offload model.

FIG. 5 is an illustration of the invention.

### A DETAILED DESCRIPTION OF PREFERRED & ALTERNATIVE EMBODIMENTS

I. Overview of the Invention

The present invention provides methods and apparatus for selective offloading of protocol processing from a host CPU to an offloading auxiliary processor. In one preferred embodiment of the invention, the auxiliary processor offloads the reception of iSCSI data over the TCP/IP network protocol, performing all necessary TCP/IP functions that occur during the normal course of a TCP/IP receive operation and all necessary iSCSI protocol functions. In the event of an error or other exceptional condition, the auxiliary processor transfers control back to the offloading host to handle the condition.

In another preferred embodiment of the invention, the auxiliary processor offloads the transmission of iSCSI data over the TCP/IP network protocol, performing all necessary TCP/IP functions that occur during the normal course of a TCP/IP transmit operation and all necessary iSCSI protocol functions. In the event of an error or other exceptional condition, the auxiliary processor transfers control back to the offloading host to handle the condition.

In other preferred embodiments, other tasks and sequences of tasks may be offloaded to the auxiliary processor. The tasks and sequences of tasks are described in further detail below.

In other preferred embodiments, other network protocols, transport protocols and application protocols may be offloaded to the auxiliary processor. The protocol may be a combination of protocols including the network protocol, the transport protocol and the application protocol. The offloaded protocols can be any protocol or set of protocols in the seven layer ISO protocol reference model. When multiple protocols of different layers are taken together, each unique combination of protocols is treated as a separate protocol. This capability allows the underlying protocols to be tailored to the requirements of the application and the application protocol. The additional protocols are described in detail below.

II. Preferred & Alternative Embodiments

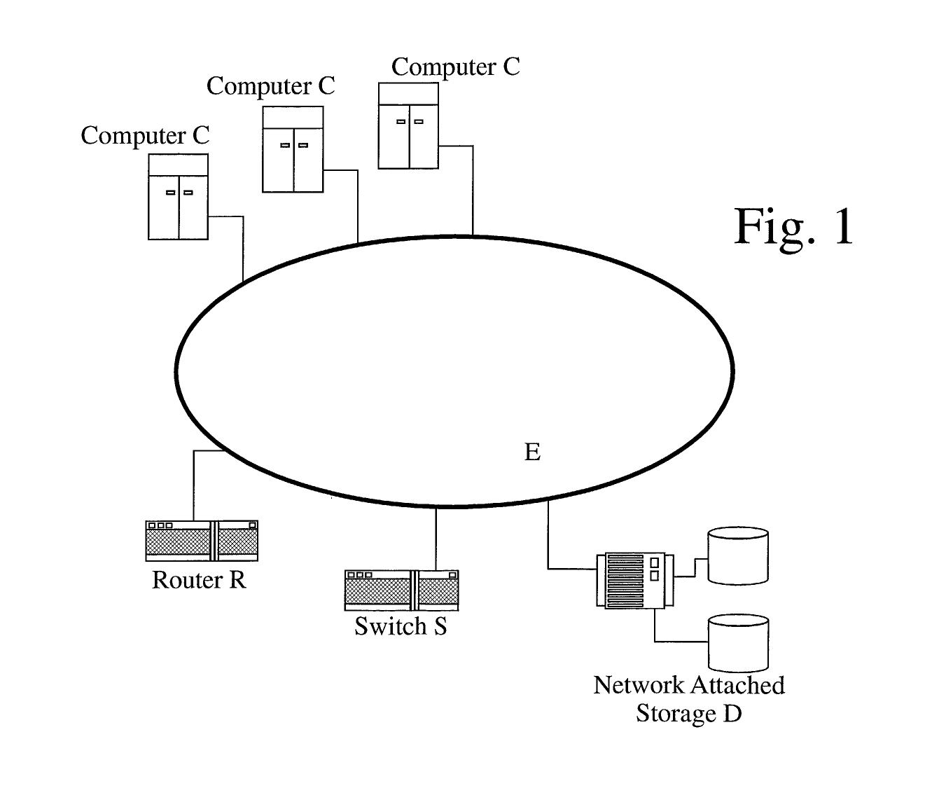

FIG. 1 generally illustrates the embodiments of a computer network to which the present invention pertains as Selective Offloading of Protocol Processing from computers C. A computer C is attached to the computer network E. The computer C is capable is communicating with other network routers R, network switches S, network storage devices D, and other computers C.

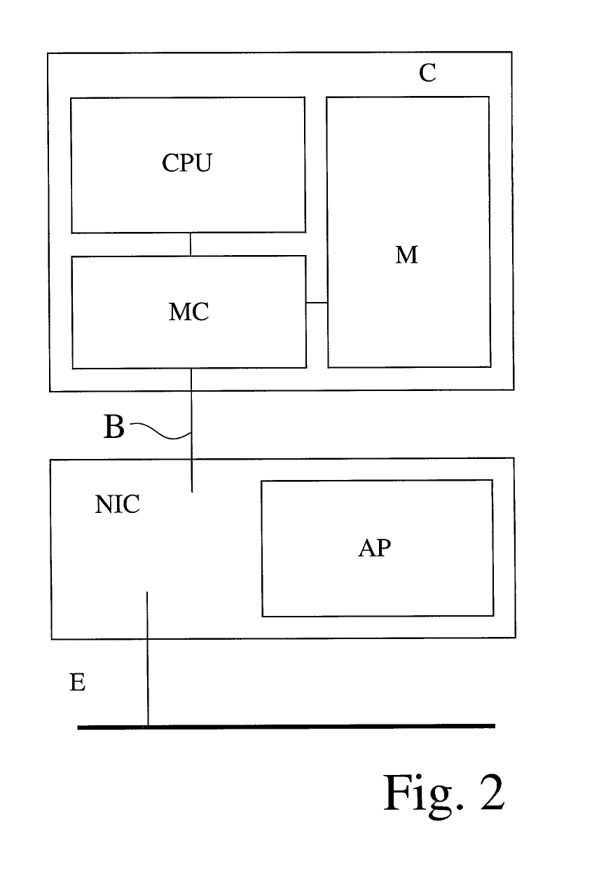

FIG. 2 is a schematic depiction of the present invention which employs auxiliary processor AP. A computer network E is connected to a network interface NIC. An auxiliary processor AP is co-located with the network interface NIC. A network interface NIC is connected to a computer C via an I/O interface B. An I/O interface B is connected to the memory controller MC. A memory controller MC is connected to the memory M and the processor CPU of computer C.

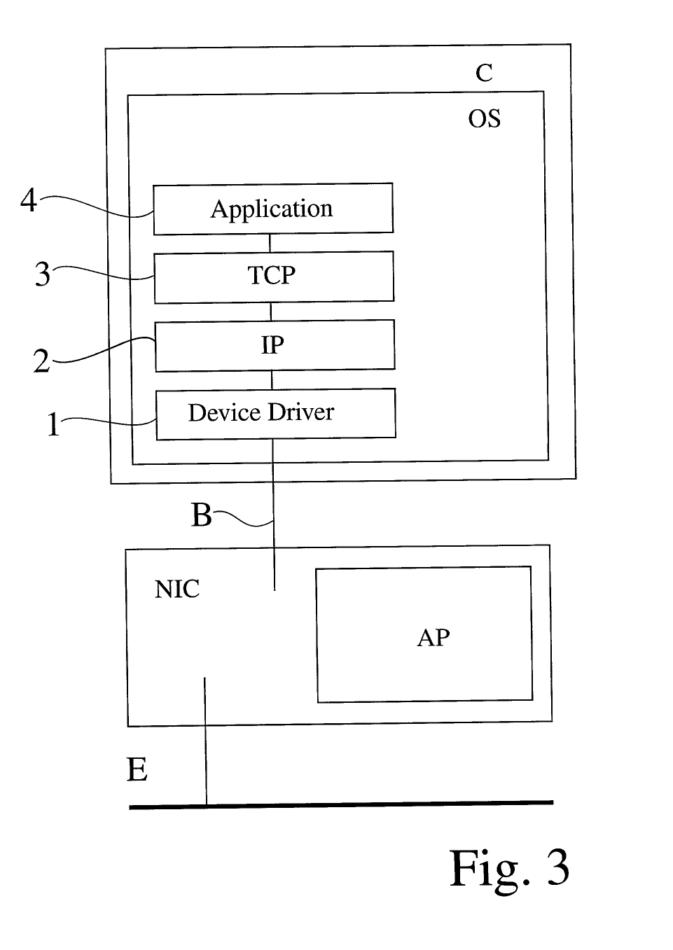

FIG. 3 is a schematic depiction showing the current model of host based protocol processing as it is usually performed in a modern computer. A computer network E is connected to a network interface NIC. A network interface NIC is connected to a computer C. Within the operating system OS of computer C, a network interface device driver function 1 communicates with the NIC and with an IP protocol processing function 2. An IP protocol processing function 2 communicates with a TCP protocol processing function 3 and a network interface device driver 1. A network application 4 communicates with the TCP protocol processing function 3. Each of the layered functional blocks, network device driver function 1, IP protocol processing function 2, and TCP protocol processing function 3 has a specific function that it performs for all data that is passed to it by the layers above and below. This is the classical arrangement of host based network protocol processing.

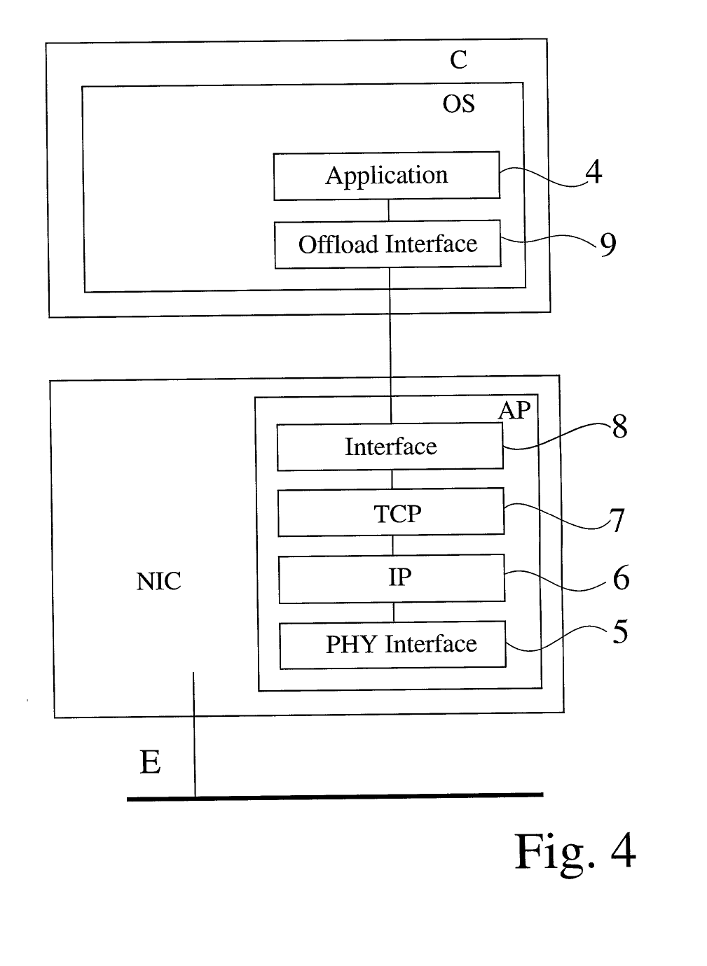

FIG. 4 is a schematic depiction showing the current model of full protocol processing offload to an auxiliary processor. A computer network E is connected to a network interface NIC. An auxiliary processor AP is co-located with the network interface NIC. A network interface NIC is connected to a computer C. Within the auxiliary processor AP, an offload network interface device driver function 5 communicates with the NIC and with an IP protocol processing function 6. An IP protocol processing function 6 communicates with a TCP protocol processing function 7 and an offload network interface device driver function 5. A TCP protocol processing function 7 communicates with the IP protocol processing function 6 and the auxiliary processor resident host offload interface function 8. The auxiliary processor resident host offload interface function 8 communicates with the TCP protocol processing function 7 and the host resident host offload interface function 9. The host resident host offload interface function 9 communicates with the auxiliary processor resident host offload interface function 8 and the network application 4. Each layer of the protocol processing block from FIG. 3 have moved from operating in the host operating system OS of computer C to operating in the auxiliary processor AP of the network interface NIC. Although this accomplishes the desired result of offloading the protocol processing from the host processor CPU, it requires that all network functions and requirements be fully implemented in the auxiliary processor AP. When all data communications are functioning normally, the resource requirements, especially the buffering of data is relatively small. When network errors and other conditions occur such as dropped or lost packets, the receipt of packets out of sequence, or the receipt of fragmented data, the resources consumed rise dramatically. Specific examples of errors and exceptional conditions that cause an increase in resource utilization include IP reassembly, TCP resequencing, loss of the first packet of a fragmented TCP segment, loss of TCP acknowledgements, loss of a packet containing application framing information, out of order TCP segments where the first TCP segment contains application framing data and other situations where due to the nature of the data that is lost or reordered, some user data must be stored for use later.

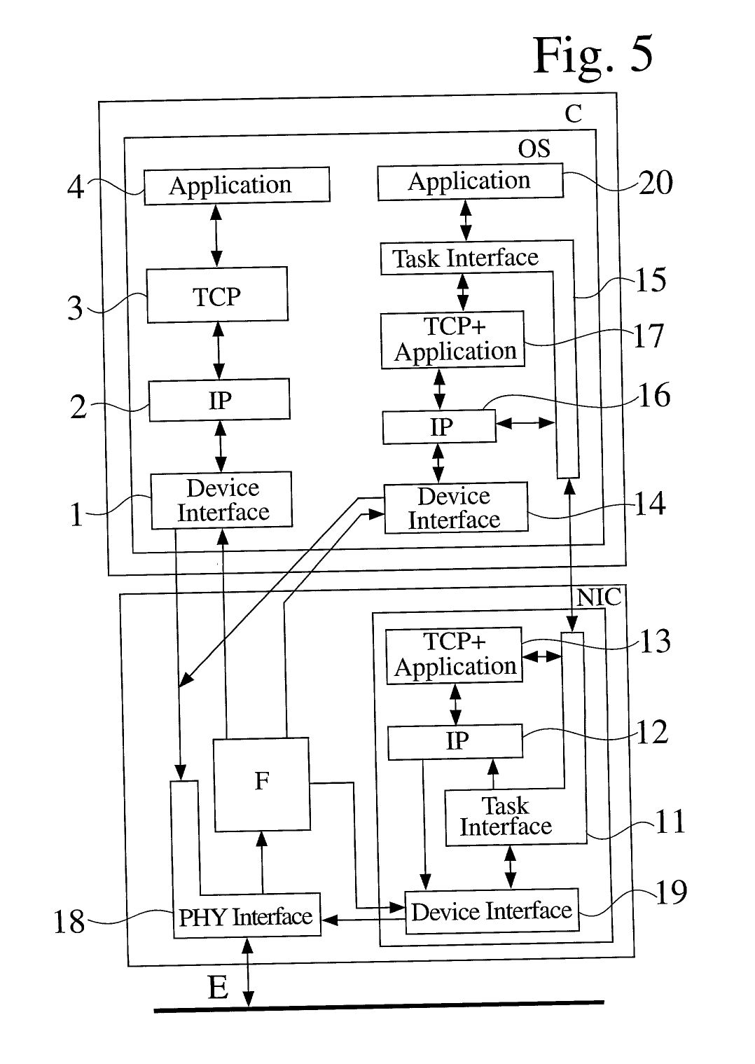

FIG. 5 is a schematic depiction of the present invention which employs auxiliary processor AP. A computer network E is connected to a physical interface function 18 of the network interface NIC. A physical interface function 18 receives data from a computer network E and sends it to a filtering function F. A physical interface function 18 receives data to transmit to a computer network E from a host network interface device driver function 1; a host resident offload protocol device driver function 14 and an AP resident offload protocol device driver function 19. A filtering function F receives inbound data from a physical interface function 18 and selects an appropriate device driver to send the received data to for processing. A filtering function F may select between a host network interface device driver function 1, a host resident offload protocol device driver function 14 or an AP resident offload protocol device driver function 19.

A host network interface device driver function 1 sends outbound data to a physical interface function 18 and inbound data to an IP protocol processing function 2. The same host network interface device driver 1 receives inbound data from a filtering function F and outbound data from an IP protocol processing function 2. An IP protocol processing function 2 communicates with a TCP protocol processing function 3 and a host network interface device driver 1. A network application 4 communicates with the TCP protocol processing function 3. Processing functions 1, 2, and 3, are the standard, unmodified, host based network protocol processing functions also depicted in FIG. 3.

An AP resident offload protocol stack device driver function 19 sends outbound data to a physical interface function 18 and inbound data to an AP resident offload task interface function 11. The same AP resident offload protocol stack device driver function 19 receives data inbound data from a filtering function F and outbound data from an AP resident offload task interface function 11 and AP resident IP protocol offload function 12. An AP resident offload task interface function 11 receives inbound data from an AP resident offload protocol stack device driver function 19 and a host resident offload task interface function 15. The same AP resident offload task interface function 11 sends outbound data to an AP resident offload protocol stack device driver function 19 and inbound data to an AP resident IP offload function 12 or a host resident offload task interface function 15. An AP resident IP offload protocol processing function 12 receives inbound data from an AP resident offload task interface function 11 and receives outbound data from an AP resident TCP+Application offload protocol processing function 13. The same AP resident IP offload protocol processing function 12 sends inbound data to an AP resident TCP+Application offload protocol processing function 13 and sends outbound data to an AP resident offload protocol stack device driver function 19. An AP resident TCP+Application offload protocol processing function 13 communicates with an AP resident IP offload protocol processing function 12 and an AP resident offload task interface function 11.

A host resident offload protocol stack device driver function 14 sends outbound data to a physical interface function 18 and sends inbound data to the host resident IP protocol offload processing function 16. The same host resident offload protocol stack device driver function 14 receives inbound data from a filtering function F and receives outbound data from host resident IP protocol offload processing function 16. A host resident IP protocol offload processing function 16 communicates with a host resident TCP+Application protocol offload processing function 17, a host resident offload protocol stack device driver function 14, and a host resident offload task interface function 15. A host resident TCP+Application protocol offload processing function 17 communicates with a host resident IP protocol offload processing function 16, and a host resident offload task interface function 15. A host resident offload task interface function 15 communicates with an AP resident offload task interface function 11, a host resident IP protocol offload processing function 16, a host resident TCP+Application protocol offload processing function 17 and the network application 20.

In addition to passing network data between the various functions, task state information is passed between the host resident task interface function 15, the host resident TCP+application offload protocol processing function 17 and the host resident IP offload protocol processing function 16. The host resident task interface function 15 is responsible for maintaining the task state information in the host. Task state information is also passed between the AP resident task interface function 11, the AP resident TCP+application offload protocol processing function 13 and the AP resident IP offload protocol function 12. The AP resident task interface function 11 is responsible for maintaining the task state information in the auxiliary processor. Task state information is passed between the host computer C and the auxiliary processor AP by the host resident task interface function 15 and the AP resident task interface function 11 respectively.

The task state information, also known as the task description includes the task request from the network application 20, state information describing the connection that was previously established and initialized, if the request pertains to a previously established connection and information to support the communications and synchronization between the host resident offload task interface function 15 and the AP resident offload task interface function 11.

Prior inventions have used combinations of the approaches shown in FIGS. 3 and 4. When these are combined directly, each implementation must implement the entire scope of the network protocol. Each implementation must handle all contingencies, errors, corner cases and unusual circumstances. The ability to have a robust host resident protocol stack with an auxiliary processor based offload engine where individual tasks are selected and transferred to the auxiliary processor for completion has been a long strived for goal. Many earlier attempts have tried to shoehorn in the task selection and transfer process into an existing host protocol stack. This has proved to be cumbersome, difficult and error prone. The results have not included an effective, robust product.

The novel use of using a parallel host resident protocol processing function that has been designed to facilitate the transfer of protocol processing tasks to and from an auxiliary protocol processor allows the original network protocol processing stack to remain unmodified, fully functional and robust, while enabling a selective protocol processing offload functionality. But this approach only solves part of the problem. The network application may be bound to the correct protocol processing stack, but classically, incoming network data is always demultiplexed in a defined order where the network layer (IP) is handled first, followed by the transport layer (TCP) until finally the data is sent to the application. The application only receives the data after the default, host based network protocol processing stack has processed it, bypassing the offload functionality.

It must also be noted that in the past when operating a host based network protocol stack and an offloaded network protocol stack, a separate network address has been required to be allocated to the offload protocol stack. This consumes network addresses and forces networking devices that communicate with the offloaded protocol stack to be aware of the existence of the offloaded protocol stack in as much as the communicating devices must address the offload protocol stack directly. This results in an additional administrative overhead where the communicating network devices must be administered to inform them of the address of the offload network protocol stack. For large numbers of network devices in complex data centers, this can be a large job and can slow deployment.

The novel use of a filter within the network interface function to determine which protocol processing function to use allows the transparent introduction of protocol offload processing. The transparency comes from the ability to use the same network address as the host protocol stack and thus does not require that any administrative action be taken to enable the communicating network devices to communicate with an additional network address.

It has been recognized that the benefit of offloading network protocol processing is directly related to the design of the application protocol that is being used. Put simply, some applications will benefit greatly when network protocol offloading is used and some will not.

The novel use of a filter selecting which protocol stack to use on the basis of the application protocol and not solely on the destination MAC address or the destination network address of the received network data enables the network protocol offload function to intelligently select which network protocol(s) are offloaded and to which network protocol processing stack the received network data is sent to for processing. This completes the enabling of the selective network protocol offload functionality. Combined with the use of dual host resident network protocol stacks, application aware filtering in the network interface allows a incoming network data to be sent to the standard host based network protocol processing function, the AP resident offload protocol processing function, the host resident offload protocol processing function, or another, application specific protocol processing function.

III. Methods of Operation of Selective Offload Protocol Processing

In FIG. 1, a network application running on computer C must establish a connection and retrieve data from the network attached storage system D. To accomplish this, in FIG. 5, network application 20 sends a request to a host resident offload task interface function 15 to open a TCP connection and perform application specific initialization with a network attached storage device D. Network application 20 is able to make this request using a host resident offload task interface function 15, because the AP and host resident TCP+Application protocol processing functions 17, 13 are able to offload the network and application protocols that network application 20 uses.

In one preferred embodiment of this invention, the task of establishing a new TCP connection and performing application specific initialization is considered a complex task that should not be offloaded to the auxiliary processor AP. A host resident offload task interface function 15 calls a host resident TCP+application offload protocol processing function with a task description. A task description includes the task request from the network application 20, the information describing the connection, and information to support the communications and synchronization between a host resident offload task interface function 15 and an AP resident offload task interface function 11. The host resident TCP+Application protocol offload processing function 17 performs the requested task, making calls to a host resident IP protocol processing function 16 which, in turn, performs the requested task, making calls to a host resident offload protocol stack device driver function 14. A host resident offload protocol stack device driver function 14 calls a physical interface function 18 and receives data from a filtering function F. Once a task has been completed, a host resident TCP+Application protocol offload processing function 17 notifies a host resident offload task interface function 15, by passing back a modified task description. A host resident task interface function 15 then notifies a network application 20.

Now that the connection between computer C and network attached storage D has been established and initialized, network application 20 calls a host resident offload task interface function 15 requesting that data be sent to network attached storage D.

In one preferred embodiment of this invention, the host resident offload task interface function 15 recognizes that this task is most efficiently accomplished by offloading it to an auxiliary processor AP, and calls an AP resident offload task interface function 11 with a task description. A task description includes the request from the network application 20, the information describing the connection that was previously established and initialized and information to support the communications and synchronization between a host resident offload task interface function 15 and a AP resident offload task interface function 11. An AP resident offload task interface function 11, upon receiving and accepting this request forwards the request to an AP resident TCP+Application protocol offload processing function 13. An AP resident TCP+Application protocol offload processing function 13 performs the requested task, making calls to an AP resident IP protocol processing function 12 which, in turn, performs the requested task, making calls to an AP resident offload protocol device driver function 19. An AP resident offload protocol device driver function 19 calls a physical interface function 18 and receives data from a filtering function F. Once a task has been completed, an AP resident task interface function 11 notifies a host resident offload task interface function 15, by passing back a modified task description. A host resident offload task interface function 15 notifies a network application 20.

A network application 20 calls a host resident offload task interface function 15 requesting that a specific piece of data be read from the network attached storage D.

In one preferred embodiment of this invention, a host resident offload task interface function 15 recognizes that this task is most efficiently accomplished by offloading it to the auxiliary processor AP, and calls an AP resident offload task interface function 11 with the task description. An AP resident offload task interface function 11, upon receiving and accepting this request forwards the request to an AP resident TCP+Application protocol offload processing function 13. An AP resident TCP+Application protocol offload processing function 13 performs the requested task, making calls to an AP resident IP protocol processing function 12 which, in turn, performs the requested task, making calls to an AP resident offload protocol device driver function 19. An AP resident offload protocol device driver function 19 calls a physical interface function 18 and receives data from a filtering function F. During the execution of the given task by an AP resident TCP+Application protocol offload processing function 13, an AP resident TCP+Application protocol offload processing function 13 detects that some of the data segments have been dropped. A full network protocol stack is required to collect the segments that have been received and acknowledge those up until the first dropped segment. The subsequent segments must be held, unacknowledged, until the missing segment(s) are received. Retaining these segments consume storage resources in the AP. In the case of selective offloading of network protocol processing, an AP resident TCP+Application protocol offload processing function 13 notifies an AP resident task interface function 11 of the loss by passing back a modified task description. An AP resident task interface function 11 notifies a host resident offload task interface function 15, by passing back a modified task description. A host resident offload task interface function 15 passes this task description to a host resident TCP+Application protocol offload processing function 17 to complete. The error recovery and the remainder of the original task is performed by a host resident TCP+Application protocol offload processing function 17. One the task has been completed; a host resident TCP+Application protocol offload processing function 17 notifies a host resident offload task interface function 15, by passing back a modified task description. A host resident offload task interface function 15 then notifies a network application 20. This demonstrates how fast path tasks can be easily offloaded to an auxiliary processor, without burdening them with error recovery and exceptional condition processing abilities. Examples of errors and exceptional conditions that should be handled by the host resident portion of the network protocol processing offload functions include IP reassembly, TCP resequencing, lost first packet of a fragmented TCP segment, lost TCP acknowledgements, lost packet containing application framing information, out of order TCP segments where the first TCP segment contains application framing data and other situations where due to the nature of the data that is lost or reordered, some user data must be stored for use later. This greatly reduces the buffering and storage requirements of the auxiliary processor.

In another example a network application 20 calls a host resident offload task interface function 15 requesting that data be sent to network attached storage D.

In one embodiment of this invention, a host resident offload task interface function 15 recognizes that this task is most efficiently accomplished by offloading it to an auxiliary processor AP, and calls an AP resident offload task interface function 11 with the task description. An AP resident offload task interface function 11 receives the request, but because of a shortage of resources, is unable to execute the requested task. An AP resident offload task interface function 11 notifies a host resident offload task interface function 15, by passing back an unmodified task description. The host resident offload task interface function 15, upon receiving an uncompleted task request, passes the request to a host resident TCP+Application protocol offload processing function for execution. This demonstrates how the selective network protocol offload may function in a limited resource environment. Resources that may cause task rejection may include frame buffer space, data frame descriptor space, CPU utilization, task descriptor space, host I/O interface bandwidth, and network interface bandwidth.

IV. Methods of Operation of the Selective Offload Filtering Function

As has been shown above, an intelligent filtering function is required to enable the functionality of Selected Offloading of Protocol Processing. The filtering rules that control the operation of a filtering function F must be able to be manipulated during the course of operation.

In a preferred embodiment, these filter rule manipulations include the ability to atomically add, delete and modify individual rules.

In an alternative embodiment, these filter rule manipulations only require that an enable bit be atomically settable and resettable, with other functions being nonatomic.

In a preferred embodiment, the size of the rule filter must accommodate the number of active tasks of the given application protocol plus a default rule to match the application and a second default rule for all non-matching traffic.

In an alternate embodiment, a much smaller rule table can be used to differentiate between offloadable application network traffic and non-offloadable network traffic.

In a preferred embodiment, the rules are composed of a plurality of single rules. This plurality of single rules can be combined logically to form a plurality of complex rules. The logical operations used for combining a plurality of single rules into a complex rule include AND, OR, NOT, NAND, and NOR.

In a preferred embodiment, the filtering function must be able to match the desired network address, the desired TCP application protocol number and be able to look into the application headers far enough to filter on the application framing data.

In an alternate embodiment, the filtering function must be able to match at least on the desired network address and the desired TCP application protocol number.

In another alternate embodiment, the filtering function should be able to compare the rules against any layer of the ISO reference protocol stack model.

In a preferred embodiment, the filtering function should be able to specify which of a plurality of protocol processing functions should receive and process the received network data.

V. Apparatus for Selective Offloading of Protocol Processing

In one preferred embodiment, the auxiliary processor function may be constructed using a processor or processors, memory, an interface to the physical network interface and an interface to the host I/O interface. The various auxiliary processor resident functions are implemented in this embodiment as firmware functions that are executed by the processor or processors.

In an alternate preferred embodiment of the auxiliary processor function, some of the repetitive protocol processing functions may be implemented using state machines in hardware in addition to the processor or processors, memory, physical network interface and host I/O interface. The form of this hardware may be gate arrays, programmable array logic (PALs), field programmable gate arrays (FPGAs), Application Specific Integrated Circuits (ASICs), quantum processors, chemical processors or other similar logic platforms. The various auxiliary processor resident functions are implemented in this embodiment as a combination of firmware functions that are executed by the processor or processors and hardware functions that are utilized by the processor or processors.

In an alternate preferred embodiment of the auxiliary processor function, the entire auxiliary processor may be implemented using hardware. The various forms of hardware are listed above

In a preferred embodiment of the network interface NIC, the network interface may be implemented as a card, designed to plug into the host computer's I/O interface such as a Peripheral Component Interconnect (PCI) interface, PCI-X interface, InfiniBand interface, GSC bus interface, AT bus interface, VME bus interface, compact PCI bus interface, PC card interface, OEMI interface, ESCON interface, future bus interface, ISA bus interface, EISA bus interface, HiPPi interface, HSC interface, LSC interface and S-100 bus interface. An embodiment of this type lets the network interface be installed after the computer has been manufactured.

In an alternate embodiment of the network interface NIC, the network interface may be implemented as a single ASIC which may be mounted on the motherboard of the computer at the time of manufacture.

In an alternate embodiment of the network interface NIC, the network interface may be implemented as a logic component of the I/O subsystem of the host computer. In this embodiment, other logic components may be combined with the offload NIC functionality in a highly complex ASIC.

In an alternate embodiment of the network interface NIC, the network interface may be implemented as a logic component of the memory subsystem of the host computer. In this embodiment, other logic components may be combined with the offload NIC functionality in a highly complex ASIC.

### CONCLUSION

Although the present invention has been described in detail with reference to particular preferred and alternative embodiments, persons possessing ordinary skill in the art to which this invention pertains will appreciate that various modifications and enhancements may be made without departing from the spirit and scope of the Claims that follow. The various hardware and software configurations that have been disclosed above are intended to educate the reader about preferred and alternative embodiments, and are not intended to constrain the limits of the invention or the scope of the Claims. The List of Reference Characters which follows is intended to provide the reader with a convenient means of identifying elements of the invention in the Specification and Drawings. This list is not intended to delineate or narrow the scope of the Claims.

### LIST OF REFERENCE CHARACTERS

AP Auxiliary processor

B I/O interface

C Computer

CPU Central processing unit

D Network attached storage

E Computer network

F Filtering function

M Memory

MC Memory controller

NIC Network interface

OS Host operating system

R Network router

S Network switch

1 Host network interface device driver

2 Host IP protocol processing function

3 Host TCP protocol processing function

4 Network application

5 Auxiliary processor network interface device driver

6 Auxiliary processor IP protocol processing function

7 Auxiliary processor TCP protocol processing function

8 Auxiliary processor side host offload interface

9 Host side host offload interface

11 Auxiliary processor resident offload task interface function

12 Auxiliary processor resident IP protocol offload processing function

13 Auxiliary processor resident TCP+Application protocol offload processing function

14 Host resident offload protocol stack device driver function

15 Host resident offload task interface function

16 Host resident IP protocol offload processing function

17 Host resident TCP+Application protocol offload processing function

18 Physical network interface function

19 Auxiliary processor resident offload protocol device driver function

20 Offload enabled network application

### SEQUENCE LISTING

Not applicable.

What is claimed is:

1. An apparatus comprising:
a host resident processor; and
an auxiliary processor coupled to said host resident processor;
said host resident processor being capable of requesting that a task be performed by said auxiliary processor;
said auxiliary processor being capable of performing protocol processing at the request of said host resident processor;
said auxiliary processor being capable of returning a completion status of said task to said host resident processor.
